(19) United States
(12) Patent Application Publication
(10) Pub. No.: US 2016/0157299 A1
(43) Pub. Date: Jun. 2, 2016

(54) System For Managing A Heating Resistor With A Positive Temperature Coefficient Of Auxiliary Electric Heating Equipment Of A Motor Vehicle

(71) Applicant: VALEO SYSTEMES THERMIQUES, Le Mesnil Saint Denis cedex (FR)

(72) Inventor: Stephane DE SOUZA, Les Essarts-le-Roi (FR)

(21) Appl. No.: 14/906,931

(22) PCT Filed: Jun. 23, 2014
(86) PCT No.: PCT/EP2014/063198

§ 371 Date: Jan. 22, 2016

(30) Foreign Application Priority Data
Jul. 22, 2013 (FR) 1357175

(51) Int. Cl. H05B 1/02

(52) U.S. Cl. CPC H05B 1/0236; H05B 2203/02

(57) ABSTRACT

The invention relates to auxiliary electric heating equipment for a motor vehicle, comprising one or more heating bars comprising resistances with a positive temperature coefficient, and an electronic power stage alternately powering each heating bar on and off, according to a cyclic ratio that can be adjusted by control means. This equipment comprises means for limiting the actual intensity of the current passing through the electronic power stage, by measuring the peak current passing through at least one heating bar and comparing the measured peak current value with a peak current value read in a table for the current cyclic ratio, and decreasing the cyclic ratio if the measured peak current exceeds the peak current value read in the lookup table. The peak current value read in the lookup table corresponding to the maximum actual current allowable by the control unit for the cyclic ratio in question.

The invention relates to auxiliary electric heating equipment of a motor vehicle intended to ensure a temporary heat contribution when the heat engine of the vehicle is not yet hot enough to provide this contribution.

### BACKGROUND OF THE INVENTION

Such auxiliary heating equipment is used for example to quickly provide the heat making it possible to defog the windows of the vehicle when the user has just started the vehicle. It includes heating rods which, for safety reasons, are formed of resistors with a positive temperature coefficient.

A resistor with a positive temperature coefficient has a resistivity that rises when the temperature of said resistor rises, which makes it possible to limit the risks of heating or of starting of a fire in the event of electrical malfunction. This is why it is compulsory to use this type of resistor for motor vehicle heating systems.

In the event of an accident, if such a rod remains powered on, it heats up because it is not ventilated due to the fact that the vehicle is stationary. This rise in temperature induces a rise in the resistivity, which causes the intensity of the current to decrease, thus limiting the risks of thermal events in the case of electrical malfunction.

In practice, in the event of an accident, the rise in temperature of a heating rod of this type which remains powered on thus remains reasonable, which makes it possible to limit the risks of a fire. By contrast, a conventional heating resistor remaining powered on in the event of an accident gives rise to a very substantial increase in temperature, which may cause a fire.

On this basis, heating equipment is dimensioned according to the given conditions, such as a predetermined flow of air of 300 kg per hour cooling the heating rods, this air having a given temperature for example of 0° C.

The regulation of the amount of heat produced by such equipment is ensured by an management electronics unit which regulates the amount of average current injected into the heating rods by alternately powering them on and off, according to an adjustable cyclic ratio. In order to adjust the amount of heat produced, the user acts on a control element, which conditions the value of the cyclic ratio.

Such auxiliary heating equipment nevertheless gives rise to a risk of malfunction in the event of extreme cold. If the user requests operation at full load while the external temperature is very low, the intensity of the current passing through the resistor or resistors and the management electronics unit may become very high. This may translate into different malfunctions and in particular an irreversible deterioration of the components of the management electronics unit.

### OBJECT OF THE INVENTION

The objective of the invention is to propose a solution in order to overcome this disadvantage.

### SUMMARY OF THE INVENTION

To this end, the invention relates to auxiliary electric heating equipment for a motor vehicle, comprising one or more heating rods comprising resistors with a positive temperature coefficient, and a power electronics stage alternately powering each heating rod on and off, according to a cyclic ratio that can be adjusted by control means, characterized in that said equipment comprises means for limiting the actual intensity of the current passing through the power electronics stage, by measuring the peak current passing through at least one heating rod, and by comparing the measured peak current value with a peak current value read in a table for the current cyclic ratio, and by decreasing the cyclic ratio if the measured peak current exceeds the peak current value read in the lookup table, the peak current value read in the lookup table corresponding to the maximum effective current value allowable by the control unit for the cyclic ratio in question.

This solution makes it possible to limit the effective current in the control unit by taking measurements of peak current which can be performed more easily than measurements of effective current in view of the substantial level of noise existing in the current signal.

The invention may also comprise means for measuring the momentary current passing through a rod as well as a microcontroller connected to these measurement means in order to cyclically interrogate said means so as to store a maximum momentary current value corresponding to the measured peak current, wherein the lookup table is stored in the microcontroller.

In accordance with one embodiment the invention also comprises a number of heating rods as well as means for measuring the momentary current in each rod.

In accordance with another embodiment the invention also comprises a number of heating rods as well as means for phase shifting the powering on and off of the different heating rods so as to limit the peak current in the management unit during operation.

In accordance with another variant the invention comprises three heating rods as well as means for phase shifting the powering on and off of these three heating rods by a third of a cycle.

### DETAILED DESCRIPTION OF THE INVENTION

The object of the invention is to limit the effective current in the heating rods at a predetermined threshold by lowering the cyclic ratio whilst measuring the value of the peak current and by using a lookup table giving, for different cyclic ratio values, the peak current value corresponding to the predetermined effective current threshold.

The lookup table is established for example on the basis of tests and measurements performed on a test bench, in which each heating rod of equipment is alternately powered on and off in accordance with a number of cyclic ratio values, this test bench being equipped with means for cooling the rods in a controlled manner.

The voltage is a nominal direct voltage of, for example, 13 volts, and the powering on and off frequency is a low frequency of, for example, 20 Hz. The different cyclic ratio values selected are for example 50%, 60%, 70%, 80% and 90%. This test makes it possible to identify for each cyclic ratio value the allowable value of the peak current, i.e. the value of the peak current corresponding to the predetermined threshold of allowable effective current (for example 111 amperes) by the management electronics unit.

The test bench makes it possible to measure the effective current passing through the power electronics unit of the heating equipment, and the peak current produced in a rod when said rod is powered on, each measurement being taken for example over a series of cycles. The peak current, or the inrush current, corresponds to the current peak produced over the rod during the moments following the powering on of said rod, prior to stabilization of the current at a nominal value.

By starting for example with the application of a cyclic ratio of 90% at 20 Hz, the effective current passing through the power electronics unit is then measured. If the effective current value is lower than the predetermined threshold of 111 amperes, the test bench is managed in order to lower the temperature of the rods. This lowering of temperature decreases the electrical resistance of the rods and hence increases the value of the effective current that passes through the power electronics unit and each rod.

The temperature of the rods is then adjusted by controlling the cooling thereof until the effective current measured has a value corresponding to the predetermined threshold, i.e. 111 amperes, the cyclic ratio being maintained at 90%. When the temperature of the rods gives rise to an effective current value of 111 amperes, this being stabilized in the power electronics unit, the test bench is controlled in order to measure the value of the peak current in each rod, i.e. the maximum value of the momentary current in the moments that follow the powering on of said rod, with each cycle.

This peak current value, here 40.5 amperes, is then stored in the lookup table in combination with the 90% cyclic ratio value and forms the peak current value in a bar corresponding to the predetermined effective current threshold allowable by the power electronics unit. In other words, if the peak current value were to become greater than 40.5 amperes under 90% cyclic ratio, the effective current in the power electronics unit would then become greater than the threshold value of 111 amperes.

The same protocol is then implemented under a cyclic ratio of 80% and makes it possible to conclude that by placing the rod at a temperature such that the effective current value is 111 amperes in the power electronics unit, the peak current value in a bar is then 45.3 amperes.

Similarly, two other tests make it possible to determine that under 70% then 60% cyclic ratio, the predetermined threshold of 111 amperes of effective current in the power electronics unit is reached when the peak current value is 52.3 and 60.2 amperes, respectively, in one or other of the rods.

Such tests thus make it possible to establish a lookup table giving, for each cyclic ratio value, the peak current value in a rod which corresponds to the effective current threshold allowable by the power electronics unit. Such a lookup table can be established on the basis of tests, but could be established just as well on the basis of a digital simulation of the operation of the components.

The table below shows the data from such a lookup table resulting from a test of the above type for the case of auxiliary heating equipment comprising three heating rods 1, 2, 3 managed by a power electronics unit denoted E.

Thus, Ic1, Ic2 and Ic3 are the peak current values in each of the three heating rods, and IcE and IeE are the peak current and effective current values in the management electronics unit E, for each cyclic ratio value. In the present case, the components of the management electronics unit E are such that the effective current value passing through this power electronics unit E must not exceed 111 amperes.

| | 60% | 70% | 80% | 90% |
|---|---|---|---|---|
| Ic1 | 60.2 | 52.3 | 45.3 | 40.5 |
| Ic2 | 60.2 | 52.3 | 45.3 | 40.5 |
| Ic3 | 60.2 | 52.3 | 45.3 | 40.5 |
| IcE | 120.4 | 156.9 | 135.9 | 121.5 |
| IeE | 111.02 | 110.95 | 111 | 110.9 |

This lookup table thus makes it possible to manage the auxiliary heating equipment so as to eliminate the risk of overcurrent. The equipment or power electronics unit thereof is thus provided with means for measuring the peak current in at least one bar, or in each bar, thus making it possible to determine in a simple but precise manner whether or not the effective current value in the electronics unit E is acceptable so as to lower the cyclic ratio in order to reduce the effective current if it is too high.

More specifically, the means for measuring the current comprise, for each rod, a probe making it possible to determine the momentary current value passing through the rod. These probes are connected to a unit of the microcontroller or analogue type, able to perform calculations and in which the lookup table is stored.

During operation the microcontroller regularly interrogates the probes, for example every 50 ms, and always records the last maximum value, thanks to a suitable algorithm, which allows it to measure the highest peak current in the different rods in a simple and reliable manner.

The microcontroller regularly reads the value of the cyclic ratio applied to the heating rods by the management unit and reads, in the lookup table, the allowable peak current value for the cyclic ratio in question. The microcontroller then compares the measured peak current value with the allowable peak current value.

If the measured peak current value is lower than the allowable peak current value, this means that the effective current in the management electronics unit E is lower than the predetermined threshold. There is thus no risk of deterioration, and therefore the microcontroller does not act on the management electronics unit.

If, by contrast, the measured peak current value is greater than the allowable peak current value for the cyclic ratio in question, this then means that the effective current in the power electronics unit E is greater than the predetermined threshold, which corresponds to a risk of deterioration or fire. In this case, the microcontroller acts on the control of the management electronics unit E in order to reduce the cyclic ratio by 10%.

In the following cycles the microcontroller takes new measurements in order to determine, in a similar manner, whether the peak current value is greater than the allowable peak current value for the new cyclic ratio. If so, it controls the control electronics unit again in order to lower the cyclic ratio by a further 10%.

Once the algorithm has been repeated a number of times, the cyclic ratio is sufficiently reduced for the value of the effective current in the power electronics unit E to be lower than the predetermined threshold value.

The table provided above, which is provided on the basis of tests or simulations, makes it possible to establish the lookup table used in order to manage the equipment, but also makes it possible to identify limit operation conditions above and below which the equipment cannot be used without risk.

In particular, this table shows that the peak current value rises when the cyclic ratio decreases if the temperature of the rods is very low. In particular, at low temperature, the peak current value in each rod and therefore in each powering on transistor associated with each rod reaches 60.2 amperes, which may correspond to an operating limit for these transistors. In this case, the microcontroller can be used in order to forbid operation of the equipment when the peak current value is greater than 60.2 amperes.

In addition, it should be noted that the situation corresponding to a cyclic ratio of 60% with an effective current value of 111 amperes in the management unit corresponds to a situation in which it is exceptionally cold, or a theoretical situation impossible to achieve in practice.

This table also makes it possible to identify the value of the peak current passing through the power electronics unit assembly during operation, which itself may also constitute another criterion to be taken into consideration in order to stop the equipment if the overall peak current value in the control electronics unit is considered too high.

Generally, in the case of equipment having three rods, all three rods are powered on and off at a low frequency of, for example, 20 Hz and at the same cyclic ratio, but in a phase-shifted manner, which contributes to significantly reducing the peak current value in the management unit E.

In other words, the currents in the three rods are phase-shifted by a third of a cycle. This is why the peak or maximum current value IcE in the management unit E is approximately three times the peak current value in each rod when the cyclic ratio is greater than two thirds (66%), since there are then necessarily periods of time during which the three rods are simultaneously powered on.

When the cyclic ratio is by contrast lower than two thirds (66%), the maximum peak current value in the management unit E is approximately only twice the peak current value in each rod due to the fact that there are no periods of time during which the three rods are powered on, but solely periods of time during which two rods at most are powered on.

The phase shifting of the different rods thus makes it possible to smooth the current in the management unit E and to limit the peak current value to which it is exposed, without affecting the thermal efficacy of the equipment.

The invention generally thus makes it possible to limit the effective current value in the equipment whilst taking simple current measurements, since it merely involves measuring maximum values of momentary current. In other words, the invention makes it possible to take into consideration the effective current of a very noisy signal without having to take an actual measurement of effective current, which is in itself a costly thing to do.

1. Auxiliary electric heating equipment for a motor vehicle, comprising one or more heating rods comprising resistors with a positive temperature coefficient, and a power electronics stage alternately powering each heating rod on and off, according to a cyclic ratio that can be adjusted by control means, wherein said equipment comprises means for limiting the actual intensity of the current passing through the power electronics stage, by measuring the peak current passing through at least one heating rod and by comparing the measured peak current value with a peak current value read in a lookup table for the current cyclic ratio, and by decreasing the cyclic ratio if the measured peak current exceeds the peak current value read in the lookup table, the peak current value read in the lookup table corresponding to the maximum effective current value allowable by a management unit for the current cyclic ratio.

2. The equipment as claimed in claim 1, comprising means for measuring the momentary current passing through a rod as well as a microcontroller connected to the measurement means in order to cyclically interrogate said means so as to store a maximum momentary current value corresponding to the measured peak current value, wherein the lookup table is stored in the microcontroller.

3. The equipment as claimed in claim 2, comprising a number of heating rods as well as means for measuring the momentary current in each rod.

4. The equipment as claimed in claim 1, comprising a number of heating rods as well as means for phase shifting the powering on and off of different heating rods so as to limit the peak current in the management unit during operation.

5. The equipment as claimed in claim 4, comprising three heating rods as well as means for phase shifting the powering on and off of the three heating rods by a third of a cycle.

6. The equipment as claimed in claim 2, comprising a number of heating rods as well as means for phase shifting the powering on and off of different heating rods so as to limit the peak current in the management unit during operation.

7. The equipment as claimed in claim 3, comprising a number of heating rods as well as means for phase shifting the powering on and off of different heating rods so as to limit the peak current in the management unit during operation.
